(19) United States
(12) Patent Application Publication
(10) Pub. No.: US 2004/0045822 A1
(43) Pub. Date: Mar. 11, 2004

(54) Gas sensor having increased number of lead wire through holes

(75) Inventor: Takashi Kojima, Kasugai-shi (JP)

Correspondence Address: NIXON & VANDERHYE, PC, 1100 N GLEBE ROAD, 8TH FLOOR, ARLINGTON, VA, 22201-4714, US

(73) Assignee: Denso Corporation, Aichi-pref., (JP)

(21) Appl. No.: 10/649,770

(22) Filed: Aug. 28, 2003

(30) Foreign Application Priority Data
Aug. 30, 2002 (JP) 2002-254064

(51) Int. Cl. G01N 27/26

(52) U.S. Cl. 204/424; 204/408

(57) ABSTRACT

An improved structure of a gas sensor is provided which has a cylindrical elastic insulator through which lead wires coupled to an external device such as a controller pass and connect with electrode terminals of a sensor element. The elastic insulator has formed therein a plurality of holes through which the lead wires pass. One of the holes is formed on a longitudinal center line of the elastic insulator. The other holes are arranged around the center one. This arrangement allows a large number of holes to be formed in the elastic insulator without sacrificing mechanical properties of the insulator such as strength, elasticity, etc.

### BACKGROUND OF THE INVENTION

1. Technical Field of the Invention

The present invention relates generally to a gas sensor which may be employed in burning control of automotive engines, and more particularly to a such gas sensor designed to have an increased number of lead wire through holes without increasing the diameter of the gas sensor.

2. Background Art

FIG. 5 shows a conventional gas sensor installed in an exhaust pipe of an automotive internal combustion engine for use in air-fuel ratio control of the engine.

The gas sensor 9 consists of a sensor element 920 disposed within a cylindrical housing 91 through an insulation porcelain 92, an air cover 911 installed on a base end of the housing 91, lead wires 923 extending from outside to inside the air cover 911 for applying the voltage to and picking up an output from the sensor element 920, and an elastic insulator 93 fitted within a base end of the air cover 911.

The elastic insulator 923 has formed therein lead through holes 930 through which the lead wires 923 pass, respectively.

The gas sensor 9 is assembled by inserting the lead wires 923 through the holes 930 and then crimping the air cover 911 from outside it to clamp the lead wires 923 firmly in the holes 930 and secure the elastic insulator 93 within the air cover 911.

The air cover 911 is made up of a first cover 913 joined to the base end of the housing 91 and an outer cover 914 surrounding the base end of the first cover 913 through a water-repellent filter 915.

The crimping of the air cover 913 is achieved at an area of contact between the first cover 913 and the outer cover 914 which is closer to the end of the air cover 913 than the water-repellent filter 915. The holes 930 are, as clearly shown in FIG. 6, arranged at corners of a square defined about the center of the elastic insulator 93.

In recent years, use of sensor elements requiring many lead wires for electrical connections to an external device such as the type which has a heater built therein and a grounding wire and the type which has a plurality of electrochemical cells has increased.

Increasing the holes in the elastic insulator without decreasing the distance between adjacent two of the holes and the distance between an outer periphery of the elastic insulator and each of the holes, that is, reducing the rigidity of the elastic insulator requires increasing the diameter of the elastic insulator. The increasing of the diameter of the elastic insulator results in an increased size of the gas sensor.

In a case where the gas sensor is used in burning control of automotive internal combustion engines, the gas sensor is usually installed in a very small space within an exhaust pipe. Large-diameter gas sensors are, therefore, unsuitable for such installation.

Recently, automotive systems in which a plurality of gas sensors are installed in the exhaust pipe of the engine is being used. In this case, small-diameter gas sensors are very useful in terms of the efficiency of installation thereof.

Reduction in diameter of the gas sensor may be achieved by decreasing the distance between adjacent two of the holes in the elastic insulator and the distance between the outer periphery of the elastic insulator and each of the holes, that is decreasing the wall thickness of the elastic insulator. However, crimping such an elastic insulator through which the lead wires are disposed from outside the air cover causes compressive stress arising from the crimping to concentrate on a thin-walled portion of the elastic insulator (e.g., a portion between each of the holes and the outer periphery of the elastic insulator). This results in great deformation of the thin-walled portion of the elastic insulator. Thus, when such an elastic insulator is exposed to a high-temperature atmosphere, it will result in increased permanent set, thus leading to reduction in ability of sealing between the holes and the lead wires. This may cause moisture to intrude into the air cover easily through a clearance between the lead wires and the holes if water splashes the gas sensor. The intrusion of moisture may result in cracks in the sensor element, thus leasing to failure or reduction in performance of the gas sensor.

Additionally, the decrease in wall thickness of the elastic insulator may also result in decreases in strength and elasticity.

### SUMMARY OF THE INVENTION

It is therefore a principal object of the invention to avoid the disadvantages of the prior art.

It is another object of the invention to provide an improved structure of a gas sensor designed to have a large number of lead wire through holes without increasing the diameter or size of the gas sensor.

According to one aspect of the invention, there is provided a gas sensor which comprises: (a) a housing; (b) a sensor element disposed within the housing; (c) a cover having a first and a second end, the cover extending at the first end from an end portion of the housing; (d) at least four lead wires extending from outside to inside the cover to establish electrical connections with the sensor element; (e) an elastic member retained within the second end of the cover. The elastic member has formed therein at least four holes through which the lead wires pass. One of the holes has a center substantially coinciding with that of the elastic member on a plane extending perpendicular to a length of the gas sensor.

In the preferred mode of the invention, the second end of the cover has a portion crimped to retain the elastic member within the cover. The elastic member experiences a 10% to 20% reduction in outer diameter due to crimping of the second end of the cover.

A minimum distance between adjacent two of the holes on the plane extending perpendicular to the length of the gas sensor is 1 mm or more. A minimum distance between an outer periphery of the elastic member and one of the holes closest to the periphery of the elastic member is 1 mm or more.

The holes may have formed on an inner wall thereof a rib which projects in a radius direction of the holes to establish elastic abutment to the lead wires and is opposed to a portion of the second end of the cover crimped to retain the elastic member within the cover in the radius direction of the holes.

The elastic member is made of an insulating material.

The holes other than the one formed in the center of the elastic member are arranged at regular intervals in a circle defined about the center of the elastic member.

### BRIEF DESPCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view of a gas sensor according to the invention;

FIG. 2 is a transverse sectional view, as taken along the line A-A in FIG. 1, which shows an internal structure of an elastic insulator installed in an end of the gas sensor of FIG. 1;

FIGS. 3(a), 3(b), 3(c), and 3(d) show modified forms of an elastic insulator;

FIG. 4(a) is a partially vertical sectional view which shows a modified form of an elastic insulator having two annular ribs formed on an inner wall of a hole;

FIG. 4(b) is a partially vertical sectional view which shows a hole of the elastic insulator of FIG. 4(a) after a lead wire is inserted into the hole, and the elastic insulator is crimped through an air cover;

FIG. 4(c) is a partially vertical sectional view which shows a modified form of an elastic insulator having three saw-edged annular ribs formed on an inner wall of a hole;

FIG. 4(d) is a partially vertical sectional view which shows a hole of the elastic insulator of FIG. 4(c) after a lead wire is inserted into the hole, and the elastic insulator is crimped through an air cover;

FIG. 5 is a longitudinal sectional view of a conventional gas sensor; and

FIG. 6 is a transverse sectional view, as taken along the line B-B in FIG. 5, which shows an internal structure of an elastic insulator installed in an end of the gas sensor of FIG. 6.

### DESCRIPTION OF THE PREFERRED EMBODIMENTS

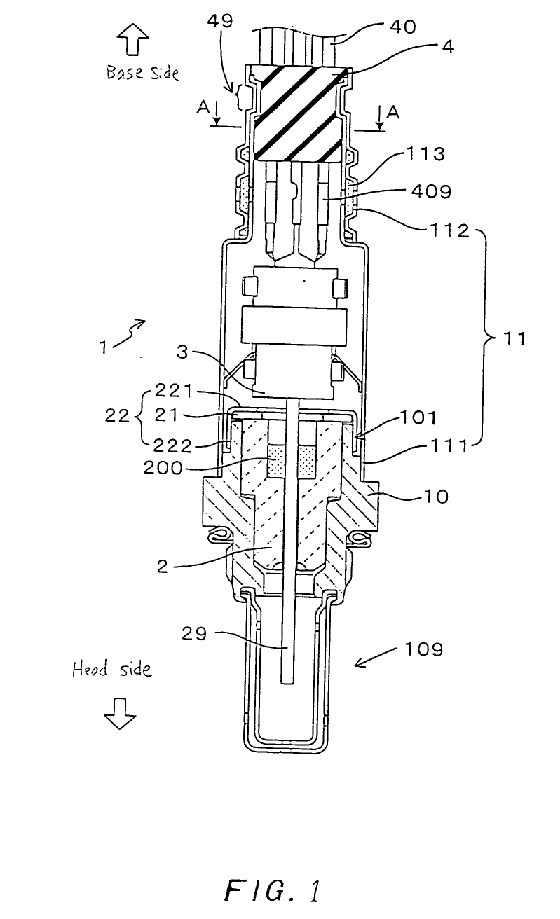

Referring to the drawings, wherein like reference numbers refer to like parts in several views, particularly to FIG. 1, there is shown a gas sensor 1 according to the invention which may be employed in a burning control system for automotive vehicles to measure concentrations of components such as NOx, CO, HC, O₂ contained in exhaust gasses of the engine.

The gas sensor 1 includes a sensor element 29, an air cover assembly 11, lead wires 40, and a cylindrical elastic insulator 4. The sensor element 29 is disposed within the housing 10 through an insulation porcelain 2. The air cover assembly 11 is made up of a first cover 111 and a second cover 112. The first cover 111 has an upper small-diameter portion, as viewed in the drawing, and an open end thereof stacked or crimped to the housing 10. The second cover 112 is installed on the periphery of the small-diameter portion of the first cover 1 11 and crimped to retain a water-repellent filter 113 around the small-diameter portion of the first cover 111. The lead wires 40 extend from outside to inside the air cover assembly 11 through the elastic insulator 4 installed within an end of the first cover 111. The lead wires 40 lead to an external device such as a controller and are used in applying the voltage to and picking up a sensor output from the sensor element 29 and supplying the power to a heater provided on the sensor element 29.

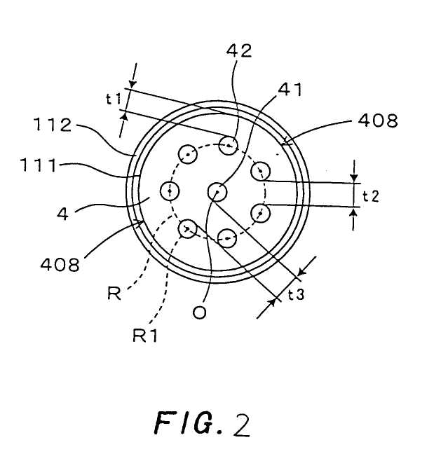

The elastic insulator 4 is made of, for example, fluororubber, silicone rubber, or acrylic rubber which is suitable for use in high temperature atmosphere such as the inside of an exhaust pipe of automotive engines and, as clearly shown in FIG. 2, has formed therein eight holes 41 and 42 through which the eight lead wires 40 pass respectively. The hole 41 is located so that the center thereof coincides with the center of the elastic insulator 4 on a plane extending perpendicular to the length (i.e., a longitudinal center line) of the gas sensor 1 (or the sensor element 29). In other words, the hole 41, the elastic insulator 4, and the sensor element 29 are aligned in longitudinal center lines thereof with each other.

The gas sensor 1 is designed to be installed in an exhaust pipe of an automotive engine to measure the concentration of O₂ and NOx to determine the air-fuel ratio of a mixture within a combustion chamber of the engine.

The sensor element 29 is made of a typical laminated ceramic plate which has a monitor cell working to monitor the concentration of oxygen within a gas chamber defined in the laminated ceramic plate, an oxygen pump cell working to regulate the concentration of oxygen within the gas chamber, and a sensor cell working to measure the concentration of NOx within the gas chamber. The ceramic plate also includes a heater which heats the ceramic plate up to a temperature required to be sensitive to gases to be measured correctly. Gas sensors of this type are well known in the art, and structure and operation thereof in detail will be omitted here.

The electric power and voltage are inputted to the heater and each cell through electrode terminals (not shown) affixed to the surface of the sensor element 29. Additionally, outputs of each cell is picked up by the controller through the electrode terminals.

The gas sensor 1 has, as described above, the three cells and the one heater and thus needs the eight lead wires 40 in total for supplying the power to the heater, applying the voltage, and transmitting outputs of the cells to the external controller.

FIG. 1 is a longitudinal sectional view of the gas sensor 1 and does not show all of the lead wires 41 for the brevity of illustration.

The gas sensor 1, as shown in FIG. 1, also includes a hollow cylindrical heat-resistant metallic housing 10, a double-walled protective cover assembly 109 made up of an outer and an inner cover, and the air cover assembly 11. The protective cover assembly 109 is installed on a head of the housing 10 to define a gas chamber into which gases to be measured are admitted through gas holes formed in the outer and inner covers. The air cover assembly 11 is, as described above, made up of the first cover 111 and the second cover 112.

The ceramic-made insulation porcelain 2 is retained within the housing 10. The insulation porcelain 2 consists of a large-diameter portion, a small-diameter portion, and a tapered shoulder therebetween. The housing 10 has an inner shoulder tapering off to the cover assembly 109. The shoulder of the insulation porcelain 2 is placed on the inner shoulder of the housing 10 through a metallic packing ring in an air-tight fashion.

A disc spring 21 is mounted on an upper end, as viewed in FIG. 1, of the insulation porcelain 2. A press assembly 22 is fitted over the upper end of the insulation porcelain 2 through the disc spring 21. The press assembly 22 is made up of a press plate 221 and an annular leg 222 extending vertically from the periphery of the press plate 221. The leg 222 is, for example, press fit over the periphery of the insulation porcelain 2 and retains the press plate 221 tightly so as to press the disc spring 21 elastically to apply an elastic pressure to the insulation porcelain 2, so that the insulation porcelain 2 is installed within the housing 10 in the air-tight fashion.

An insulation porcelain 3 is disposed above the insulation porcelain 2 within the air cover assembly 11. The insulation porcelain 3 has retained therein terminal springs (not shown) which establish electrical contact with the electrode terminals of the sensor element 29. The terminal springs are connected electrically to the lead wires 40 through connectors 409, respectively.

The elastic insulator 4 is, as described above, fitted on the open end of the first cover 112 far from the housing 10 and has the holes 42 arranged around the center hole 41.

The hole 41, as described above, has the longitudinal center line coinciding with that of the elastic insulator 4. “O” in FIG. 2 indicates the longitudinal center lines of the hole 41 and the elastic insulator 4. The other holes 42 are so arrayed that the centers R1 (i.e., longitudinal center lines) thereof lie on a circle R whose center is defined on the longitudinal center line O. The holes 42 are arranged preferably at regular intervals, so that intervals between the adjacent holes 42 and intervals between the outer peripheral wall of the elastic insulator 4 and the holes 42 will be equal to each other, thereby minimizing the degree of concentration of stress arising from the crimping of the air cover assembly 11.

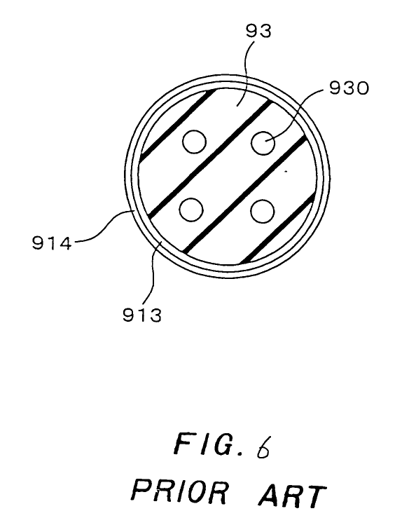

The formation of the hole 41 to have the center coinciding with the center of the elastic insulator 4 on a plane extending perpendicular to the length of the gas sensor 1 permits a sectional area of the elastic insulator 4 extending perpendicular to the length of the elastic insulator 4 to be minimized without sacrificing required mechanical strength, elasticity, etc. Specifically, as compared with the conventional structure, as illustrated in FIG. 6, in which no hole is formed in the center of the elastic insulator 93, the structure of this embodiment allows intervals between adjacent two of the holes 42 surrounding the center hole 41 and between the outer periphery of the elastic insulator 4 and each of the holes 42 to be increased or the elastic insulator 4 to be decreased in diameter without changing the above intervals, that is, without reducing the mechanical properties of the insulator 4 as long as the holes 930 in the conventional structure and the holes 41 and 42 in this embodiment are identical in number.

The elastic insulator 4 may alternatively be made of a polygonal member. In this case, the center hole 41 is preferably formed in the center of gravity of the insulator 4.

An allowable shift between the center of the hole 41 and the center of the elastic insulator is within a range of 20% of the diameter of the hole 41.

If a minimum wall thickness or distance between the holes 42 and an outermost surface 408 of the elastic insulator 4 is defined as t1, a minimum distance between adjacent two of the holes 42 is defined as t2, and the distance between the center hole 41 and the holes 42 is defined as t3, they are all more than or equal to 1 mm for ensuring resistance to deformation of the elastic insulator 4 and required degree of liquid-tightness between the holes 41 and 42 and the lead wires 40. A preferable upper limit of the distances t1, t2, and t3 is 3 mm in terms of compactness of the gas sensor 1. For instance, t1=1.3 mm, t2=1.8 mm, and t3=2.35 mm.

The air cover assembly 11 is, as described above, crimped at a portion, as indicated at numeral 49 in FIG. 1, in a radius direction thereof to secure the elastic insulator 4 therewithin. This crimping preferably results in 10% to 20% reduction in outer diameter of the elastic insulator 4. If the reduction is less than 10%, it may result in a lack of compressive pressure acting on the elastic insulator 4, thus leading to a lack of liquid-tightness between the lead wires 40 and the holes 41 and 42. Alternatively, if the reduction is more than 20%, it may result in excess of compressive pressure acting on the elastic insulator 4, thus leading to cracks in the elastic insulator 4. For instance, the outer diameter of the elastic insulator 4 before and after installed within the air cover assembly 11 is 12.8 mm and 10.8 mm, respectively.

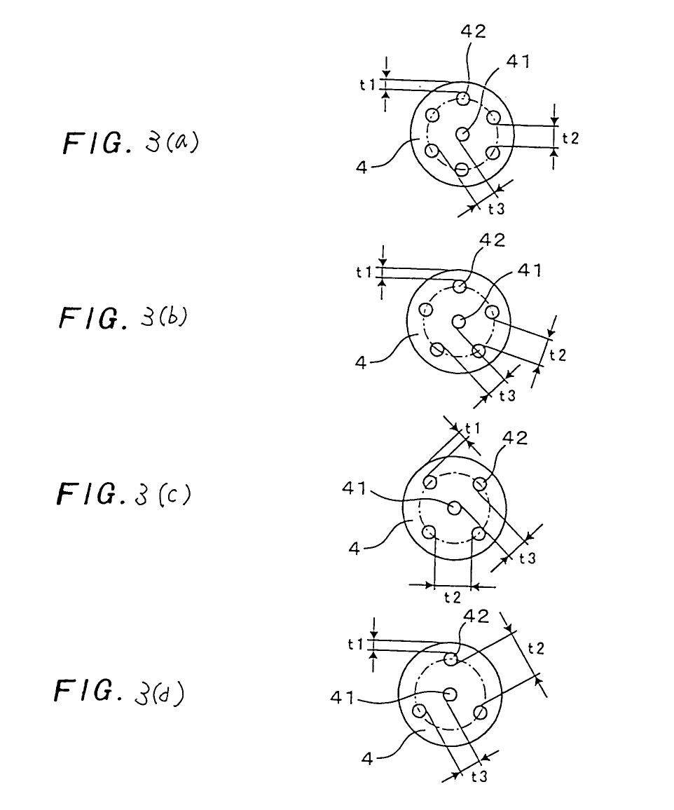

FIGS. 3(a), 3(b), 3(c), and 3(d) show modifications of the elastic insulator 4.

FIG. 3(a) illustrates for a case where the gas sensor 1 uses seven lead wires 40. The elastic insulator 4, thus, has formed therein six holes 42 around the center hole 41.

FIG. 3(b) illustrates for a case where the gas sensor 1 uses six lead wires 40. The elastic insulator 4, thus, has formed therein five holes 42 around the center hole 41.

FIG. 3(c) illustrates for a case where the gas sensor 1 uses five lead wires 40. The elastic insulator 4, thus, has formed therein four holes 42 around the center hole 41.

FIG. 3(d) illustrates for a case where the gas sensor 1 uses four lead wires 40. The elastic insulator 4, thus, has formed therein three holes 42 around the center hole 41.

Symbols t1, t2, and t3 in FIGS. 3(a) to 3(d) indicate the same dimensions as used in FIG. 2. Other arrangements and effects in each of the modifications are the same as those in the first embodiment, and explanation thereof in detail will be omitted here.

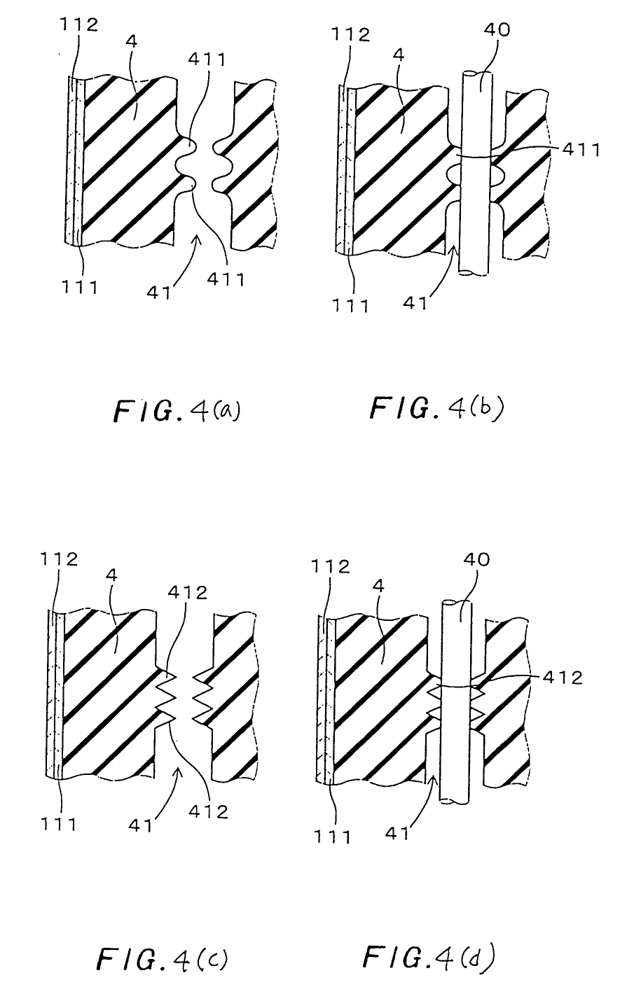

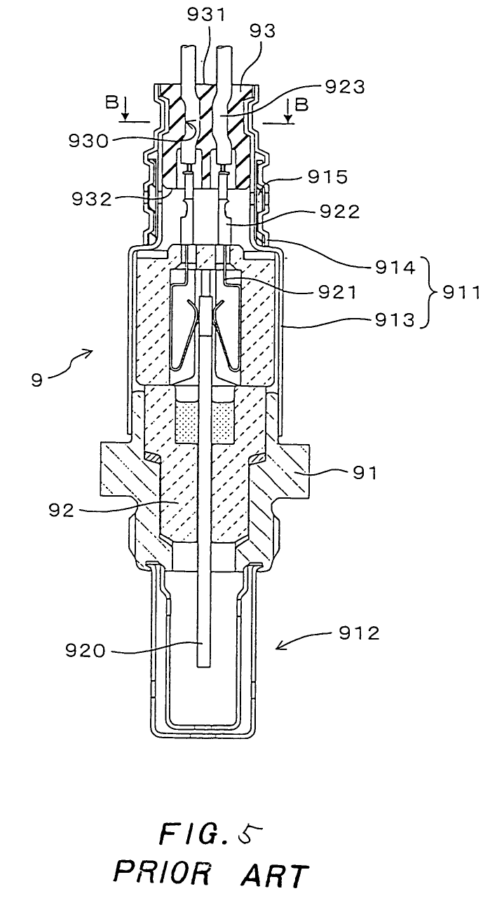

FIGS. 4(a), 4(b), 4(c), and 4(d) show modifications of the elastic insulator 4 which have inner ribs.

In a case, as illustrated in FIG. 4(a), the hole 41 has formed on an inner wall thereof two annular ribs 411 which project in a radius direction thereof and are laid in the lengthwise direction of the hole 41. The ribs 411 are preferably opposed to the crimped portion 49 of the air cover assembly 11 in the radius direction of the gas sensor 1. In this case, the crimping of the portion 49 results in or enhances, as shown in FIG. 4(b), deformation of the ribs 411 to achieve elastic abutment to the lead wire 40, thereby providing an liquid- and air-tight seal therebetween.

In a case, as illustrated in FIG. 4(c), the holes 41 has formed on the inner wall thereof three saw-edged annular ribs 412 which are laid in the lengthwise direction of the hole 41. The ribs 412 are preferably opposed to the crimped portion 49 of the air cover assembly 11 in the radius direction of the gas sensor 1. In this case, the crimping of the portion 49 results in or enhances, as shown in FIG. 4(d), deformation of the ribs 412 to achieve elastic abutment to the lead wire 40, thereby providing a liquid- and air-tight seal therebetween.

The ribs 411 or 412 may also be formed in each of the holes 42.

In a case where the inner diameter of the ribs 411 or 412 is small enough to clamp the lead wire 40 firmly, they may alternatively be shifted from the crimped portion 49 of the air cover assembly 11 vertically.

The ribs 411 or 412, as described above, may be formed at a location where the pressure produced by the crimping of the air cover assembly 11 acts on the ribs 411 or 412. This enhances the hermetic sealing between the ribs 411 or 412 and the lead wire 40 and also reduces the need for concern about dimensional accuracy of the lead wires 40 and the holes 41. Specifically, it is possible to form a certain degree of clearance between the lead wire 40 and the hole 41, thus facilitating ease of installation of the lead wires 30 within the elastic insulator 4.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas sensor comprising:
a housing;
a sensor element disposed within said housing;
a cover having a first and a second end, said cover extending at the first end from an end portion of said housing;
at least four lead wires extending from outside to inside said cover to establish electrical connections with said sensor element;
an elastic member retained within the second end of said cover, said elastic member having formed therein at least four holes through which said lead wires pass, one of the holes having a center substantially coinciding with that of said elastic member on a plane extending perpendicular to a length of the gas sensor.

2. A gas sensor as set forth in claim 1, wherein the second end of said cover has a portion crimped to retain said elastic member within said cover, and wherein said elastic member experiences a 10% to 20% reduction in outer diameter due to crimping of the second end of said cover.

3. A gas sensor as set forth in claim 1, wherein a minimum distance between adjacent two of the holes on the plane extending perpendicular to the length of the gas sensor is 1 mm or more, and wherein a minimum distance between an outer periphery of said elastic member and one of the holes closest to the periphery of said elastic member is 1 mm or more.

4. A gas sensor as set forth in claim 1, wherein the holes have formed on an inner wall thereof a rib which projects in a radius direction of the holes to establish elastic abutment to the lead wires and is opposed to a portion of the second end of said cover crimped to retain said elastic member within said cover in the radius direction of the holes.

5. A gas sensor as set forth in claim 1, wherein said elastic member is made of an insulating material.

6. A gas sensor as set forth in claim 1, wherein the holes other than the one formed in the center of said elastic member are arranged at regular intervals in a circle defined about the center of said elastic member.
